(19) United States
(12) Patent Application Publication
(10) Pub. No.: US 2010/0315486 A1
(43) Pub. Date: Dec. 16, 2010

(54) STEREOSCOPIC VIDEO SERVICE PROVIDING/RECEIVING METHOD AND APPARATUS IN DIGITAL BROADCASTING SYSTEM

(75) Inventors: Gwang-Soon LEE, Daejeon (KR); Hyun Lee, Daejeon (KR); Bong-Ho Lee, Daejeon (KR); Kug-Jin Yun, Daejeon (KR); Nam-Ho Hur, Daejeon (KR); Jin-Woong Kim, Daejeon (KR); Kwang-Hee Jung, Gyeonggi-do (KR); Soo-In Lee, Daejeon (KR); Seung-Ho Shin, Incheon (KR); Heon-Ju Park, Seoul (KR); Young-Ho Jo, Seoul (KR); Duk-Won Oh, Seoul (KR)

Correspondence Address: STAAS & HALSEY LLP, SUITE 700, 1201 NEW YORK AVENUE, N.W., WASHINGTON, DC, 20005, US

(73) Assignees: ELECTRONICS AND TELECOMMUNICATION RESEARCH INSTITUTE, Daejeon (KR); TU MEDIA CORP., Seoul (KR)

(21) Appl. No.: 12/814,801

(22) Filed: Jun. 14, 2010

(30) Foreign Application Priority Data
Jun. 15, 2009 (KR) 10-2009-0053026
Jun. 3, 2010 (KR) 10-2010-0052284

(51) Int. Cl. H04N 13/00

(52) U.S. Cl. 348/42; 348/E13.001

(57) ABSTRACT

Provided is a stereoscopic video service providing method using a stereoscopic video stream including first and second video streams in a digital broadcasting system. The stereoscopic video service providing method includes: generating information on the first video stream and information on the second video stream; inserting an identifier of the information on the second video stream into the information on the first video stream; and transmitting the first video stream and the information on the first video stream and the second video stream and the information on the second video stream through separate transmission channels, respectively.

### CROSS-REFERENCE(S) TO RELATED APPLICATIONS

The present application claims priority of Korean Patent Application Nos. 10-2009-0053026 and 10-2010-0052284, filed on Jun. 15, 2009, and Jun. 3, 2010, respectively, which are incorporated herein by reference in their entirety.

### BACKGROUND OF THE INVENTION

1. Field of the Invention

Exemplary embodiments of the present invention relate to a stereoscopic video service providing/receiving method and apparatus in a digital broadcasting system.

2. Description of Related Art

A stereoscopic video stream includes a variety of video formats such as a side-by-side format and a top-down format. Currently, the side-by-side format and the top-down format are most widely used as a format dedicated to 3D TV. However, the two formats have a problem in guaranteeing backward compatibility. That is, the stereoscopic video stream with such a format may be encoded, transmitted, and decoded even in an existing 2D broadcasting system. However, when the stereoscopic video stream is reproduced in an existing 2D terminal, left and right images may be simultaneously reproduced on one screen.

To solve such a problem, the left and right images as shown in FIG. 1 may be encoded independently or encoded through cross reference, and then transmitted as a dual video stream. The stereoscopic dual video stream includes a reference video elementary stream (ES) and a stereoscopic additional video ES. When the reference video ES is a video stream obtained by encoding the left images, the stereoscopic additional video ES becomes a video stream obtained by encoding the right images. Similarly, when the reference video ES is a video stream obtained by encoding the right images, the stereoscopic additional video ES becomes a video stream obtained by encoding the left images. The stereoscopic additional video ES may be encoded by referring to the reference video ES or independently encoded. Through such a process, the existing 2D terminal may perfectly construct a general screen by decoding only the reference video stream.

Conventionally, when the encoded dual video stream is transmitted through a broadcasting network or communication network, a single transmission channel was allocated. In the present invention, the transmission channel may include a multiplexed channel in a physical layer, which is secured by transmission techniques such as 8-Vestigital Sideband Modulation (VSB), Orthogonal Frequency Division Multiplexing (OFDM), and Code Division Multiplexing (CDM), and a channel in a transport layer, such as MPEG-2 transport stream (TS). The physical layer channel may be formed within a single frequency bandwidth by the above-described transmission techniques. However, the physical layer channel may be formed within a single frequency bandwidth by hierarchical modulation or formed by different frequency bands.

Even in the case of the Satellite Digital Multimedia Broadcasting (DMB) (TTAS.Ko-07.0027/R1; satellite digital multimedia broadcasting transmission/reception matching standard) which is mobile broadcasting, the stereoscopic video service is provided to users having a satellite DMB terminal through a single transmission channel.

When a digital broadcasting system transmits a video stream through a single transmission channel, a dual video stream generated by encoding left and right separate images through a 3D AV encoder is multiplexed into a single TS packet, and then transmitted through a single physical channel of the digital broadcasting system. The transmission through the single transmission channel has an advantage in signaling and synchronization of left and right images. Furthermore, when the left and right images are encoded, the allocation of bit rates may be flexibly set depending on time.

However, the transmission through the single transmission channel has the following disadvantages. When a 3D broadcasting signal created by using a dual video stream is broadcast, the existing 2D broadcasting terminal should unnecessarily perform channel decoding and TS de-packetizing on the stereoscopic additional video ES. Such a disadvantage may act as a factor which increases the power consumption of the 2D broadcasting terminal in 3D TV broadcasting. In particular, the disadvantage may act as a serious obstacle in the mobile broadcasting such as DMB. Furthermore, in the case of high-quality digital broadcasting such as Advanced Television Systems Committee (ATSC) broadcasting, a frequency bandwidth allocated to each broadcasting company is limited. Therefore, in order to transmit a 3D broadcasting signal with a high quality, the stereoscopic additional video ES needs to be transmitted through a separate frequency bandwidth. Even in this case, the transmission through the single transmission channel may exhibit a problem.

### SUMMARY OF THE INVENTION

An embodiment of the present invention is directed to a stereoscopic video service providing/receiving method and apparatus in a digital broadcasting system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, there is provided a stereoscopic video service providing method using a stereoscopic video stream including first and second video streams in a digital broadcasting system. The stereoscopic video service providing method includes: generating information on the first video stream and information on the second video stream; inserting an identifier of the information on the second video stream into the information on the first video stream; and transmitting the first video stream and the information on the first video stream and the second video stream and the information on the second video stream through separate transmission channels, respectively.

In accordance with another embodiment of the present invention, there is provided a stereoscopic video service receiving method using a stereoscopic video stream including first and second video streams in a digital broadcasting system. The stereoscopic video service receiving method includes: receiving the first video stream and information on the first video stream and the second video stream and information on the second video stream through separate transmission channels, respectively; extracting the information on the second video stream by using an identifier of the information on the second video stream, which is contained in the information on the first video stream; and reproducing the stereoscopic video by using the first video stream secured on the basis of the information on the first video stream and the second video stream secured on the basis of the information on the second video stream.

In accordance with another embodiment of the present invention, there is provided a stereoscopic video service providing apparatus using a stereoscopic video stream including first and second video streams in a digital broadcasting system. The stereoscopic video service providing apparatus includes: a packet generation unit configured to generate the first video stream, the second video stream, information on the first video stream, and information on the second video stream; a control unit configured to insert an identifier of the information on the second video stream into the information on the first video stream; and a transmission unit configured to perform a control to transmit the first video stream and the information on the first video stream and the second video stream and the information on the second video stream through separate transmission channels, respectively.

In accordance with another embodiment of the present invention, there is provided a stereoscopic video service receiving apparatus using a stereoscopic video stream including first and second video streams in a digital broadcasting system. The stereoscopic video service receiving apparatus includes: a reception unit configured to receive the first video stream and information on the first video stream and the second video stream and information on the second video stream through separate transmission channels, respectively; a control unit configured to perform a control to secure the first video stream by using the information on the first video stream, extract the information on the second video stream by using an identifier of the information on the second video stream, which is contained in the information on the first video stream, and secure the second video stream by using the extracted information on the second video stream; and a reproduction unit configured to reproduce the stereoscopic video by using the secured first and second video streams.

### BRIEF DESCRIPTION OF THE DRAWINGS

FIG. 1 is a diagram illustrating left and right separate images used in a stereoscopic video service.

FIG. 2 is a diagram illustrating the configuration of a digital broadcasting system in accordance with an embodiment of the present invention.

FIG. 3 is a diagram explaining a stereoscopic video service providing/receiving method in accordance with another embodiment of the present invention.

FIG. 4 is a diagram explaining a descriptor including information on a stereoscopic additional video stream in accordance with the embodiment of the present invention.

FIG. 5 is a flow chart showing the stereoscopic video service providing method in accordance with the embodiment of the present invention.

FIG. 6 is a flow chart showing the stereoscopic video service receiving method in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

First, a stereoscopic video stream in accordance with an embodiment of the present invention will be described.

The stereoscopic video stream includes a reference video stream and a stereoscopic additional video stream. The reference video stream refers to a video stream obtained by encoding a reference image, and the stereoscopic additional video stream refers to a video stream obtained by encoding a stereoscopic additional image. The stereoscopic additional video stream may be generated by encoding the stereoscopic additional image with reference to the reference image or independently encoding the stereoscopic additional image.

The reference image refers to an image which is compatibly recognized and reproduced by a conventional 2D broadcasting terminal, for example, a 2D DMB terminal, or an image which is reproduced in the 2D reproduction mode. The stereoscopic additional image refers to an image which has a different view point from the reference image. For example, when the reference image is a left view point image, the stereoscopic additional image may become a right view point image. When the reference image is a right view point image, the stereoscopic additional image may become a left view point image. A moving image service, which provides a cubic effect to a user by using such a stereoscopic video stream, refers to a stereoscopic video service.

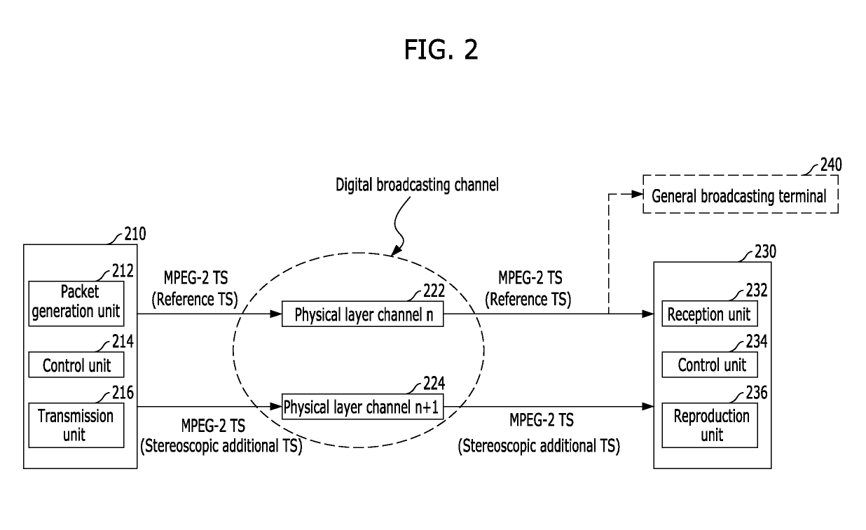

Hereafter, referring to FIG. 2, a method for transmitting a dual video stream for the stereoscopic video service from a digital broadcasting network to a dual transmission channel will be described.

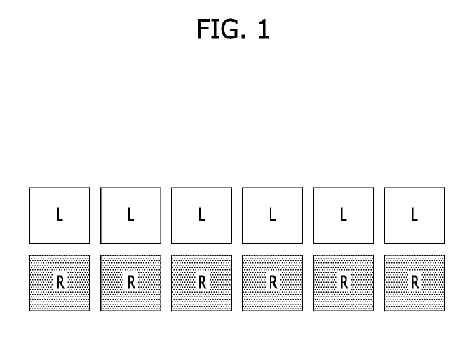

A dual video stream including a reference video stream and a stereoscopic additional video stream, which is generated by encoding left and right separate images as shown in FIG. 1 through a 3D AV encoder, is packetized and multiplexed to generate a dual MPEG-2 transport stream (TS).

Referring to FIG. 2, the dual MPEG-2 TS includes a reference MPEG-2 TS and a stereoscopic additional MPEG-2 TS. The reference MPEG-2 TS refers to a transport stream generated by packetizing and multiplexing the reference video stream, and the stereoscopic additional MPEG-2 TS refers to a transport stream generated by packetizing and multiplexing the stereoscopic additional video stream. For example, the dual MPEG-2 TS may be configured as a pair of [reference video+audio] and [stereoscopic additional video] or may be configured as a pair of [reference video+audio] and [stereoscopic additional video+multi-channel additional audio] in consideration of a multi-channel audio service. The configuration may differ depending on various service models.

The respective MPEG-2 TSs may be generated by using the same system clock, and synchronized by using a time stamp. The respective MPEG-2 TSs generated in such a manner is transmitted through separate channels allocated by a physical layer of the digital broadcasting. Therefore, channel coding/decoding processes such as Reed-Solomon coding/decoding, interleaving, and convolutional coding/decoding may be performed in parallel to the respective MPEG-2 TSs.

When the dual MPEG-2 TS is transmitted through dual transmission channels 222 and 224, a 3D broadcasting terminal 230 simultaneously channel-decodes and de-packetizes the two channels 222 and 224 including a physical layer channel n and a physical layer channel n+1, and secures a reference video stream and a stereoscopic additional video stream. On the other hand, a general 2D broadcasting terminal, for example, a 2D DMB terminal 240 channel-decodes and de-packetizes only one channel 222, that is, the physical layer channel n, and secures only a reference video stream required for 2D video reproduction. Therefore, it is possible to perfectly secure backward compatibility in terms of power consumption which is considered to be important in mobile broadcasting.

Furthermore, different channel code rates may be applied to two channels depending on network design. In a pay broadcasting system, conditional access (CA) may be applied to two channels to provide a differentiated charge model.

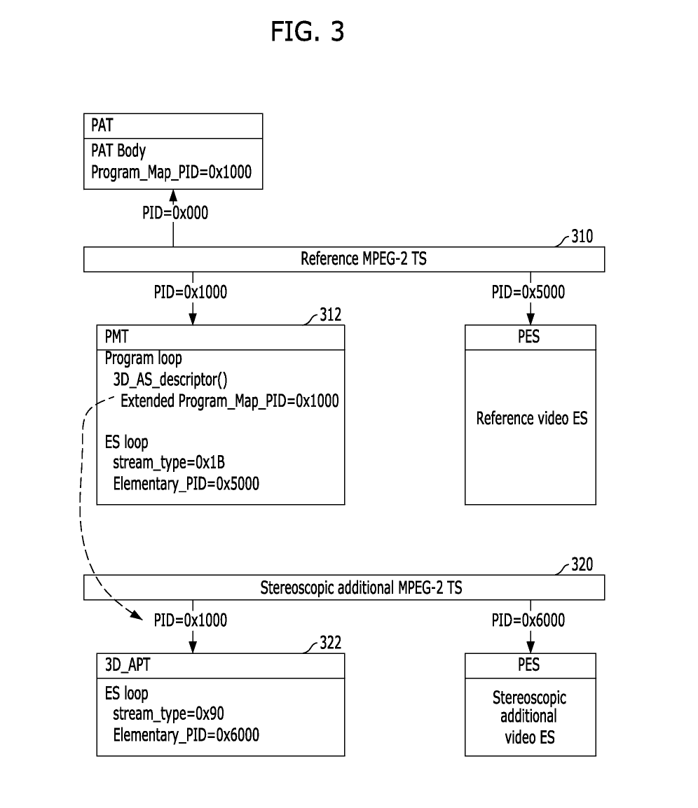

Hereafter, referring to FIGS. 3, 5, and 6, a stereoscopic video service providing/receiving method in a digital broadcasting system in accordance with an embodiment of the present invention will be described.

In a step S502, the stereoscopic video service providing apparatus generates information on first and second video streams. For example, the first video stream may be a reference video stream (reference video ES), and the second video stream may be a stereoscopic additional video stream (stereoscopic additional video ES).

The information on the reference video stream may include an ID (Elementary_PID) of a packet containing the reference video stream and a stream type (stream_type) indicating that the corresponding video stream is a reference video stream among stereoscopic video streams. Here, the stream type of the reference video stream may be defined as ‘0x1B’ representing ‘AVC video stream’. Referring to FIG. 3, such information on the reference video stream is included in a program map table (PMT) 312 of a reference MPEG-2 TS 310.

The information on the stereoscopic additional video stream may include an ID (Elementary_PID) of a packet containing the stereoscopic additional video stream and a stream type (stream_type) indicating that the corresponding video stream is a stereoscopic additional video stream among the stereoscopic video streams. The stream type of the stereoscopic additional video stream may be defined as ‘0x90 ’ representing ‘Stereoscopic Additional’. Referring to FIG. 3, such information on the stereoscopic additional video stream is included in a 3D auxiliary program table (3D_APT) 322 of the stereoscopic additional MPEG-2 TS 320.

The 3D_APT defines stereoscopic additional video or audio streams which belong to one program and are transmitted as a separate MPEG-2 TS from the reference video stream, and has the same structure as the PMT, as shown in Table 1. To satisfy such an MPEG-2 system standard that one broadcasting program should be described by one PMT information, a 3D TV service is provided through two MPGE-2 TSs including a reference MPEG-2 TS and a stereoscopic additional MPEG-2 TS. However, only one PMT is implemented to maintain the concept of one program.

TABLE 1

| Syntax | Bit number | Remark |
|---|---|---|
| 3D_Auxiliary_Program_Table ( ) { | | |
| table_id | 8 | |
| : | | |
| for (i=0; i<N1; i++) { | | |
| stream_type | 8 | 0x90 |
| Reserved | | |
| elementary_PID | 13 | |
| : | | |
| : | | |
| } | | |

In a step S504, the stereoscopic video service providing apparatus inserts an identifier of the information on the second video stream (stereoscopic additional video stream) into the information on the first video stream (reference video stream). Referring to FIG. 3, the identifier of the information on the stereoscopic additional video stream 322 is inserted into the information on the reference video stream.

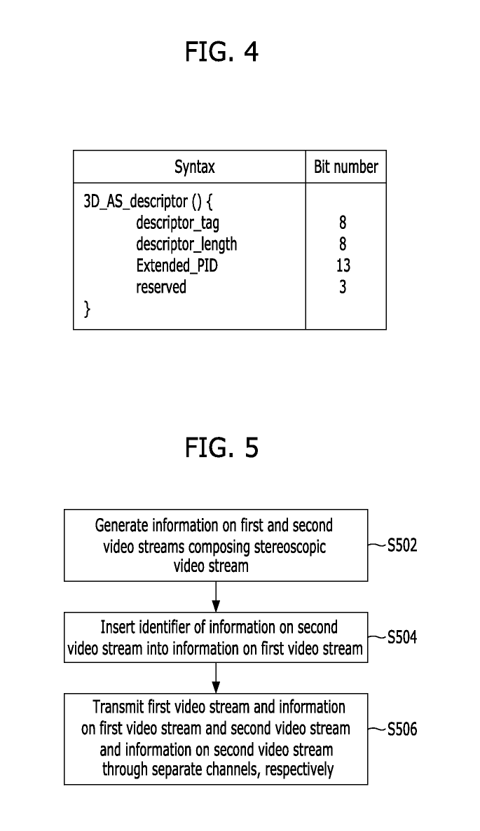

In accordance with the embodiment of the present invention, a new descriptor for informing that the stereoscopic additional video is transmitted through a different transmission channel in a 3D video service and representing the correlation between transmission channels may be defined in the PMT 312 of the reference PMEG-2 TS 310. The new descriptor (3D_AS_descriptor) may be defined as shown in FIG. 4. Specifically, descriptor tag represents an identifier of the corresponding descriptor and may be determined as one of tag values defined as user private, descriptor_length represents the length of the corresponding descriptor, Extended_PID represents the identifier of the information 322 on the stereoscopic additional video stream to be transmitted through the stereoscopic additional MPEG-2 TS. The identifier of the information 322 on the stereoscopic additional video stream may be the ID (PID) of a packet including the information 322 on the stereoscopic additional video stream, for example. Referring to FIG. 3, Extended_PID within 3D_AS_descriptor is reconciled with the PID of 3D_APT transmitted through the stereoscopic additional MPEG-2 TS to indicate 3D_APT within the stereoscopic additional MPEG-2 TS in the PMT of the reference MPEG-2 TS. A descriptor (3D_service_descriptor) which represents the information on the stereoscopic video service to be provided is included in PMT of the reference MPEG-2 TS.

In a step S506, the stereoscopic video service providing apparatus transmits the first video stream and the information on the first video stream and the second video stream and the information on the second video stream through separate transmission channels, respectively. For example, the reference video stream and the information 312 on the reference video stream are transmitted through the physical layer channel n (222), and the stereoscopic additional stream and the information 322 on the stereoscopic additional stream are transmitted through the physical layer channel n+1 (224). This has been already described above with reference to FIG. 2.

In a step S602, the stereoscopic video service receiving apparatus receives the first video stream and the information on the first video stream and the second video stream and the information on the second video stream through separate transmission channels, respectively. For example, the reference video stream and the information 312 on the reference video stream are received through the physical layer channel n (222), and the stereoscopic additional stream and the information 322 on the stereoscopic additional stream are received through the physical layer channel n+1 (224).

Then, the stereoscopic video service receiving apparatus secures the first video stream by using the information on the first video stream in a step S604. Referring to FIG. 3, the reference video stream may be secured by using the packet ID (0x5000) of the reference video stream described in the PMT 312 of the reference MPEG-2 TS 310. At this time, the stream type (0x1B) may indicate which packet ID among packet IDs described in the PMT 312 of the reference MPEG-2 TS 310 is the ID of the packet including the reference video stream.

Furthermore, the stereoscopic video service receiving apparatus extracts the information on the second video stream by using the identifier of the information on the second video stream, which is included in the information on the first video stream, in a step S606, and secures the second video stream by using the information on the second video stream extracted in the step S606 in a step S608. Referring to FIG. 3, 3D_AS_descriptor described in the PMT 312 of the reference MPEG-2 TS 310 is used. That is, the packet ID (0x1000) of 3D_APT transmitted through the stereoscopic additional MPEG-2 TS 320 may be figured out by referring to Extended_PID described in the descriptor 3D_AS_descriptor. Then, the stereoscopic additional video stream may be secured by using the packet ID (0x6000) of the stereoscopic additional video stream described in 3D_APT 322 of the stereoscopic additional MPEG-2 TS 320. At this time, the stream type (0x90) may indicate which packet ID among packet IDs described in 3D_APT 322 of the stereoscopic additional MPEG-2 TS 320 is the ID of the packet including the stereoscopic additional video stream.

The steps S606 and S608 may be performed in parallel to the step S604, and the sequence thereof may be changed. That is, the steps S606 and S608 may be performed prior to the step S604.

In a step S610, the stereoscopic video service receiving apparatus reproduces the stereoscopic video by using the secured first and second video streams. At this time, the two channels 222 and 224 may be channel-decoded and de-packetized to secure the reference video stream and the stereoscopic additional video stream, as described above.

FIG. 2 is a diagram illustrating the configuration of a digital broadcasting system in accordance with another embodiment of the present invention. Referring to FIG. 2, the digital broadcasting system includes a stereoscopic video service providing apparatus 210 and a stereoscopic service receiving apparatus 230.

The stereoscopic video service providing apparatus 210 refers to an apparatus which provides a stereoscopic video service, and includes a packet generation unit 212, a control unit 214, and a transmission unit 216.

The packet generation unit 212 is configured to generate a first video stream, a second video stream, information on the first video stream, and information on the second video stream. The detailed descriptions of this operation have been already made in the step S502 of FIG. 5.

The control unit 214 is configured to perform a control to insert an identifier of the information on the second video stream into the information on the first video stream. The detailed descriptions of this operation have been already made in the step S504 of FIG. 5.

The transmission unit 216 is configured to transmit the first video stream and the information on the first video stream and the second video stream and the information on the second video stream through separate transmission channels, respectively. The detailed descriptions of this operation have been already made in the step S506 of FIG. 5.

The stereoscopic video service receiving apparatus 230 refers to an apparatus which receives a stereoscopic video service, and may be a user terminal. The stereoscopic video service receiving apparatus 230 includes a reception unit 232, a control unit 234, and a reproduction unit 236.

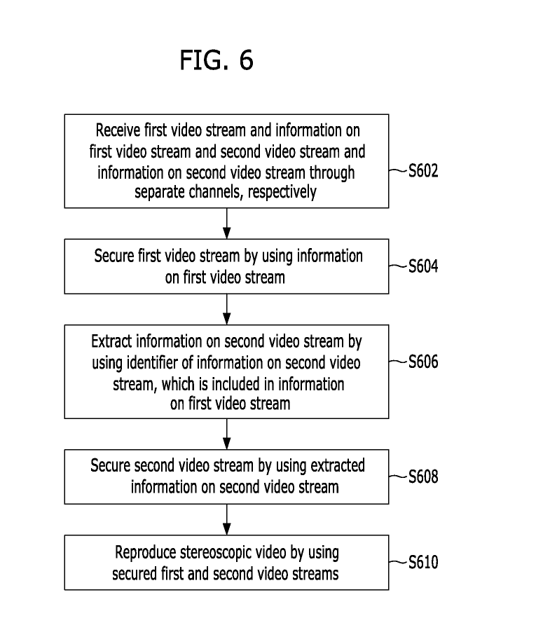

The reception unit 232 is configured to receive the first video stream and the information on the first video stream and the second video stream and the information on the second video stream through separate transmission channels, respectively. The detailed descriptions of this operation have been already made in the step S602 of FIG. 6.

The control unit 234 is configured to perform a control to secure the first video stream by using the information on the first video stream, extract the information on the second information by using the information of the information on the second video stream, which is included in the information on the first video stream, and secure the second video stream by using the extracted information on the second video stream. The detailed descriptions of this operation have been already made in the steps S604, S606, and S608 of FIG. 6.

The reproduction unit 236 is configured to reproduce the stereoscopic video by using the secured first and second video stream. The detailed descriptions of this operation have been already made in the step S610 of FIG. 6.

The stereoscopic video service providing/receiving method and apparatus may be applied to a variety of mobile broadcasting services such as satellite DMB, terrestrial DMB, and mobile IPTV as well as high-quality digital broadcasting.

In accordance with the embodiments of the present invention, the stereoscopic video service providing/receiving method and apparatus may provide a 3D video service while maintaining perfect compatibility with existing methods through a digital broadcasting network. That is, a 3D terminal providing a 3D function may receive and decode a dual video stream at the same time to receive a 3D video service, and a general 2D terminal may receive and decode only a reference video stream to receive a 2D video service. Furthermore, since the 2D terminal does not need to receive an unnecessary stereoscopic additional video stream, it is possible to reduce the power consumption.

Furthermore, in order to provide a 3D broadcasting service while maintaining a high quality in high-quality digital broadcasting, a stereoscopic additional video ES may be transmitted through a separate frequency bandwidth.

Furthermore, a variety of business models related to the 3D video service may be provided.

The stereoscopic video service providing/receiving method in accordance with the embodiments of the present invention can also be embodied as computer readable codes and stored in a computer readable recording medium including CD-ROMs, random-access memory (RAM), read-only memory (ROM), floppy disks, hard disks, optical magnetic disks and so on. Such a process may be easily construed by those skilled in the art to which the present invention pertains.

While the present invention has been described with respect to the specific embodiments, it will be apparent to those skilled in the art that various changes and modifications may be made without departing from the spirit and scope of the invention as defined in the following claims.

What is claimed is:

1. A stereoscopic video service providing method using a stereoscopic video stream comprising first and second video streams in a digital broadcasting system, the stereoscopic video service providing method comprising:
generating information on the first video stream and information on the second video stream;
inserting an identifier of the information on the second video stream into the information on the first video stream; and
transmitting the first video stream and the information on the first video stream and the second video stream and the information on the second video stream through separate transmission channels, respectively.

2. The stereoscopic video service providing method of claim 1, wherein the second video stream has a different view point from that of the first video stream.

3. The stereoscopic video service providing method of claim 1, wherein the information on the first video stream comprises an ID of a packet containing the first video stream and a stream type representing the first video stream among stereoscopic video streams, and
the information on the second vide stream comprises an ID of a packet containing the second video stream and a stream type representing the second video stream among stereoscopic video streams.

4. The stereoscopic video service providing method of claim 1, wherein the information on the first video stream is contained in a program map table (PMT), and the information on the second video stream is contained in a table which is defined to have the same structure as the PMT.

5. The stereoscopic video service providing method of claim 1, wherein the identifier of the information on the second video stream comprises the information on the second video stream.

6. A stereoscopic video service receiving method using a stereoscopic video stream comprising first and second video streams in a digital broadcasting system, the stereoscopic video service receiving method comprising:
receiving the first video stream and information on the first video stream and the second video stream and information on the second video stream through separate transmission channels, respectively;
extracting the information on the second video stream by using an identifier of the information on the second video stream, which is contained in the information on the first video stream; and
reproducing the stereoscopic video by using the first video stream secured on the basis of the information on the first video stream and the second video stream secured on the basis of the information on the second video stream.

7. The stereoscopic video service receiving method of claim 6, wherein the second video stream has a different view point from the first video stream.

8. The stereoscopic video service receiving method of claim 6, wherein the information on the first video stream comprises an ID of a packet containing the first video stream and a stream type representing the first video stream among stereoscopic video streams, and
the information on the second vide stream comprises an ID of a packet containing the second video stream and a stream type representing the second video stream among stereoscopic video streams.

9. The stereoscopic video service receiving method of claim 6, wherein the information on the first video stream is contained in a program map table (PMT), and the information on the second video stream is contained in a table which is defined to have the same structure as the PMT.

10. The stereoscopic video service receiving method of claim 6, wherein the identifier of the information on the second video stream comprises the information on the second video stream.

11. A stereoscopic video service providing apparatus using a stereoscopic video stream comprising first and second video streams in a digital broadcasting system, the stereoscopic video service providing apparatus comprising:
a packet generation unit configured to generate the first video stream, the second video stream, information on the first video stream, and information on the second video stream;
a control unit configured to insert an identifier of the information on the second video stream into the information on the first video stream; and
a transmission unit configured to perform a control to transmit the first video stream and the information on the first video stream and the second video stream and the information on the second video stream through separate transmission channels, respectively.

12. The stereoscopic video service providing apparatus of claim 11, wherein the second video stream has a different view point from that of the first video stream.

13. The stereoscopic video service providing apparatus of claim 11, wherein the information on the first video stream comprises an ID of a packet containing the first video stream and a stream type representing the first video stream among stereoscopic video streams, and
the information on the second vide stream comprises an ID of a packet containing the second video stream and a stream type representing the second video stream among stereoscopic video streams.

14. The stereoscopic video service providing apparatus of claim 11, wherein the information on the first video stream is contained in a program map table (PMT), and the information on the second video stream is contained in a table which is defined to have the same structure as the PMT.

15. The stereoscopic video service providing apparatus of claim 11, wherein the identifier of the information on the second video stream comprises the information on the second video stream.

16. A stereoscopic video service receiving apparatus using a stereoscopic video stream comprising first and second video streams in a digital broadcasting system, the stereoscopic video service receiving apparatus comprising:
a reception unit configured to receive the first video stream and information on the first video stream and the second video stream and information on the second video stream through separate transmission channels, respectively;
a control unit configured to perform a control to secure the first video stream by using the information on the first video stream, extract the information on the second video stream by using an identifier of the information on the second video stream, which is contained in the information on the first video stream, and secure the second video stream by using the extracted information on the second video stream; and
a reproduction unit configured to reproduce the stereoscopic video by using the secured first and second video streams.

17. The stereoscopic video service receiving apparatus of claim 16, wherein the second video stream has a different view point from the first video stream.

18. The stereoscopic video service receiving apparatus of claim 16, wherein the information on the first video stream comprises an ID of a packet containing the first video stream and a stream type representing the first video stream among stereoscopic video streams, and
the information on the second vide stream comprises an ID of a packet containing the second video stream and a stream type representing the second video stream among stereoscopic video streams.

19. The stereoscopic video service receiving apparatus of claim 16, wherein the information on the first video stream is contained in a program map table (PMT), and the information on the second video stream is contained in a table which is defined to have the same structure as the PMT.

20. The stereoscopic video service receiving apparatus of claim 16, wherein the identifier of the information on the second video stream comprises the information on the second video stream.
